(19) United States
(12) Patent Application Publication
(10) Pub. No.: US 2024/0177355 A1
(43) Pub. Date: May 30, 2024

(54) SUB-MESH ZIPPERING

(71) Applicants: SONY GROUP CORPORATION, Tokyo (JP); Sony Corporation of America, New York, NY (US)

(72) Inventors: Danillo Graziosi, Flagstaff, AZ (US); Alexandre Zaghetto, San Jose, CA (US); Ali Tabatabai, Cupertino, CA (US)

(21) Appl. No.: 18/394,042

(22) Filed: Dec. 22, 2023

Related U.S. Application Data
(63) Continuation-in-part of application No. 17/987,847, filed on Nov. 15, 2022.
(60) Provisional application No. 63/513,305, filed on Jul. 12, 2023.
(60) Provisional application No. 63/269,911, filed on Mar. 25, 2022.

(51) Int. Cl. G06T 9/20; G06T 9/00

(52) U.S. Cl. CPC G06T 9/20; G06T 9/001

(57) ABSTRACT

A new SEI message for the V-DMC standard is described herein, the zippering SEI. The zippering SEI message can be used by the decoder for the mesh reconstruction, where in the case of multiple sub-meshes, the zippering SEI provides ways to reduce common artifacts caused by independent sub-mesh encoding, such as holes and cracks on the mesh surface.

### CROSS-REFERENCE TO RELATED APPLICATION(S)

This application is a continuation-in-part application of co-pending U.S. patent application Ser. No. 17/987,847, filed on Nov. 15, 2022, and titled, “MESH ZIPPERING,” which claims priority under 35 U.S.C. § 119(e) of the U.S. Provisional Patent Application Ser. No. 63/269,911, filed Mar. 25, 2022 and titled, “MESH ZIPPERING, and this application claims priority under 35 U.S.C. § 119(e) of the U.S. Provisional Patent Application Ser. No. 63/513,305, filed Jul. 12, 2023 and titled, “SUB-MESH ZIPPERING,” which are all hereby incorporated by reference in their entireties for all purposes.

### FIELD OF THE INVENTION

The present invention relates to three dimensional graphics. More specifically, the present invention relates to coding of three dimensional graphics.

### BACKGROUND OF THE INVENTION

Recently, a novel method to compress volumetric content, such as point clouds, based on projection from 3D to 2D is being standardized. The method, also known as V3C (visual volumetric video-based compression), maps the 3D volumetric data into several 2D patches, and then further arranges the patches into an atlas image, which is subsequently encoded with a video encoder. The atlas images correspond to the geometry of the points, the respective texture, and an occupancy map that indicates which of the positions are to be considered for the point cloud reconstruction.

In 2017, MPEG had issued a call for proposal (CfP) for compression of point clouds. After evaluation of several proposals, currently MPEG is considering two different technologies for point cloud compression: 3D native coding technology (based on octree and similar coding methods), or 3D to 2D projection, followed by traditional video coding. In the case of dynamic 3D scenes, MPEG is using a test model software (TMC2) based on patch surface modeling, projection of patches from 3D to 2D image, and coding the 2D image with video encoders such as HEVC. This method has proven to be more efficient than native 3D coding, and is able to achieve competitive bitrates at acceptable quality.

Due to the success for coding 3D point clouds of the projection-based method (also known as the video-based method, or V-PCC), the standard is expected to include in future versions further 3D data, such as 3D meshes. However, current version of the standard is only suitable for the transmission of an unconnected set of points, so there is nomechanism to send the connectivity of points, as it is required in 3D mesh compression.

Methods have been proposed to extend the functionality of V-PCC to meshes as well. One possible way is to encode the vertices using V-PCC, and then the connectivity using a mesh compression approach, like TFAN or Edgebreaker. The limitation of this method is that the original mesh has to be dense, so that the point cloud generated from the vertices is not sparse and can be efficiently encoded after projection. Moreover, the order of the vertices affect the coding of connectivity, and different method to reorganize the mesh connectivity have been proposed. An alternative way to encode a sparse mesh is to use the RAW patch data to encode the vertices position in 3D. Since RAW patches encode (x,y,z) directly, in this method all the vertices are encoded as RAW data, while the connectivity is encoded by a similar mesh compression method, as mentioned before. Notice that in the RAW patch, the vertices may be sent in any preferred order, so the order generated from connectivity encoding can be used. The method can encode sparse point clouds, however, RAW patches are not efficient to encode 3D data, and further data such as the attributes of the triangle faces may be missing from this approach.

### SUMMARY OF THE INVENTION

A new SEI message for the V-DMC standard is described herein, the zippering SEI. The zippering SEI message can be used by the decoder for the mesh reconstruction, where in the case of multiple sub-meshes, the zippering SEI provides ways to reduce common artifacts caused by independent sub-mesh encoding, such as holes and cracks on the mesh surface.

In one aspect, a method programmed in a non-transitory memory of a device comprises determining one or more border points in one or more sub-meshes, selecting a zippering implementation from a plurality of mesh zippering implementations and merging each of the one or more border points with a corresponding point based on the selected mesh zippering implementation. The plurality of mesh zippering implementations comprise: a defined search distance implementation, a maximum distance in all sub-meshes and all frames implementation, a maximum distance per frame implementation, a maximum distance per sub-mesh implementation, a maximum distance of each boundary vertex and a matching index between two boundary vertices. The defined search distance implementation uses a user-defined search distance. The defined search distance implementation uses a computer-generated search distance using artificial intelligence and machine learning. The defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance. The distance is a radius of a spherical search area. Determining the one or more border points in the one or more sub-meshes includes determining each point on an edge that does not have two triangles connected to the edge.

In another aspect, an apparatus comprises a non-transitory memory for storing an application, the application for: determining one or more border points in one or more sub-meshes, selecting a zippering implementation from a plurality of mesh zippering implementations and merging each of the one or more border points with a corresponding point based on the selected mesh zippering implementation and a processor coupled to the memory, the processor configured for processing the application. The plurality of mesh zippering implementations comprise: a defined search distance implementation, a maximum distance in all sub-meshes and all frames implementation, a maximum distance per frame implementation, a maximum distance per sub-mesh implementation, a maximum distance of each boundary vertex and a matching index between two boundary vertices. The defined search distance implementation uses a user-defined search distance. The defined search distance implementation uses a computer-generated search distance using artificial intelligence and machine learning. The defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance. The distance is a radius of a spherical search area. Determining the one or more border points in the one or more sub-meshes includes determining each point on an edge that does not have two triangles connected to the edge.

In another aspect, a system comprises an encoder configured for encoding content and a decoder configured for: determining one or more border points in one or more sub-meshes, selecting a zippering implementation from a plurality of mesh zippering implementations and merging each of the one or more border points with a corresponding point based on the selected mesh zippering implementation. The plurality of mesh zippering implementations comprise: a defined search distance implementation, a maximum distance in all sub-meshes and all frames implementation, a maximum distance per frame implementation, a maximum distance per sub-mesh implementation, a maximum distance of each boundary vertex and a matching index between two boundary vertices. The defined search distance implementation uses a user-defined search distance. The defined search distance implementation uses a computer-generated search distance using artificial intelligence and machine learning. The defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance. The distance is a radius of a spherical search area. Determining the one or more border points in the one or more sub-meshes includes determining each point on an edge that does not have two triangles connected to the edge.

### BRIEF DESCRIPTION OF THE DRAWINGS

FIG. 1 illustrates a flowchart of a method of mesh zippering according to some embodiments.

FIG. 2 illustrates images of aspects of zippering according to some embodiments.

FIG. 3 illustrates images showing advantages and disadvantages of each zippering implementation according to some embodiments.

FIG. 4 illustrates a block diagram of an exemplary computing device configured to implement the mesh zippering method according to some embodiments.

FIG. 5 illustrates a diagram of a V-DMC V3C decoder according to some embodiments.

FIG. 6 illustrates an image of finding border vertices according to some embodiments.

FIG. 7 illustrates an image of Method 0 of distance zippering according to some embodiments.

FIG. 8 illustrates an image of Method 1 of distance zippering according to some embodiments.

FIG. 9 illustrates an image of Method 2 of distance zippering according to some embodiments.

FIG. 10 illustrates an image of Method 3 of distance zippering according to some embodiments.

FIG. 11 illustrates an image of Method 4 of distance zippering according to some embodiments.

FIG. 12 illustrates an image of Method 5 of distance zippering according to some embodiments.

FIG. 13 illustrates results for the zippering algorithm according to some embodiments.

### DETAILED DESCRIPTION OF THE PREFERRED EMBODIMENT

Ways to improve mesh reconstruction by modifying the position of vertices at the border of patches to make sure that neighboring patches do not have a gap between them, also known as zippering, are described herein. Six different methods to implement the post-processing operation, as well as syntax elements and semantics for transmission of the filter parameters, are disclosed. A hierarchical method indicate the geometry distortion that can generate gaps between patches. The value per frame, or per patch, or per boundary object is sent. The number of bits to encode the values is also dependent on the previous geometry distortion. A method sends index matches instead of geometry distortion. The matching index is sent per boundary vertex, but a method to send only one index of the pair is implemented as well.

As described in U.S. patent application Ser. No. 17/161,300, filed Jan. 28, 2021, titled, “PROJECTION-BASED MESH COMPRESSION” and U.S. Provisional Patent Application Ser. No. 62/991,128, filed Mar. 18, 2020 and titled, “PROJECTION-BASED MESH COMPRESSION,” which are hereby incorporated by reference in their entireties for all purposes, zippering addresses the issue of misaligned vertices.

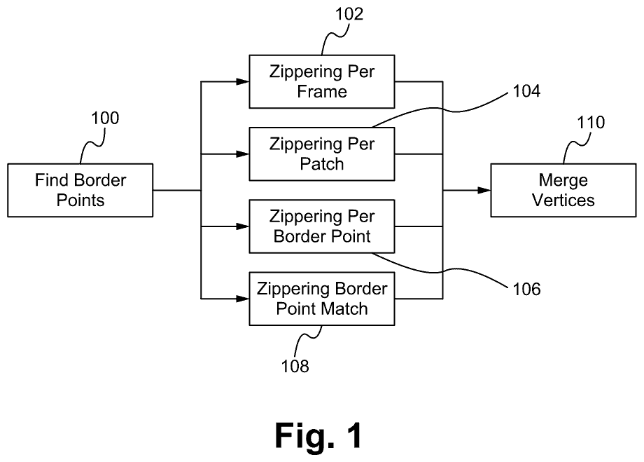

FIG. 1 illustrates a flowchart of a method of mesh zippering according to some embodiments. In the step 100, border points are found. The border points are able to be found in any manner. After the border points are found, mesh zippering is implemented. Mesh zippering includes determining neighbors of the bordering vertices and merging specific neighboring bordering vertices. The mesh zippering is able to be implemented using one or more different implementations. Mesh zippering is utilized to find points/vertices that match to remove any gaps in a mesh. To find the matching points, a search is performed in the 3D space by searching neighboring points of a point. The search is able to be limited in scope (e.g., based on a fixed value such as a maximum distance of 5 or based on a maximum distortion). Therefore, if the distance is larger than 5, the point will never find its match. The search is also able to be limited based on a maximum distortion. The maximum distortion for each point may be different. Mesh zippering per sequence is able to use distance or maximum distortion to limit the search. Since searching based on the maximum distortion may be too time consuming or computationally expensive for an entire sequence, searching on a per frame basis may be better. For example, most frames are searched based on a fixed value (e.g., maximum distance), but one specific frame is searched based on the maximum distortion. The maximum distortion is able to be implemented on a per patch basis. For example, there are patches that are large, and the distortion may be smaller. In another example, there are patches that are small, and the distortion may be larger. The distortion is able to be sent on a per border/boundary point case. No search is performed with this implementation; rather, the distortion is applied as received. However, more distortion information is sent, so the bitrate is higher, but the mesh reconstruction is better (e.g., more accurate).

In the step 102, zippering per frame is implemented. As described, the zippering performs a search for each point in a frame using a maximum distortion. By performing zippering per frame instead of an entire sequence, some processing is performed without distortion information, and only frames that are more distorted use the zippering based on a maximum distortion. In the step 104, zippering per patch is implemented. By performing zippering per patch, some processing is performed without distortion information, and only patches that are more distorted use the zippering based on a maximum distortion. In the step 106, zippering per border point is implemented. No search is performed with zippering per border point; rather, the distortion is applied as received. However, more distortion information is sent, so the bitrate is higher, but the mesh reconstruction is better (e.g., more accurate). In the step 108, zippering border point match is implemented. Indices that are matched to each other are sent. The decoder will determine where the patches go in the 3D space based on the matching vertices (e.g., averaging a distance between two points or selecting one of the points). The zippering implementation is able to be selected in any manner such as being programmed in or adaptively selected based on a set of detected criteria (e.g., detecting that a frame or patch includes a distortion amount higher than a threshold).

In the step 110, vertices are merged. Merging the vertices is able to be performed in any manner. In some embodiments, fewer or additional steps are implemented. In some embodiments, the order of the steps is modified. The zippering implementations are performed on the decoder side.

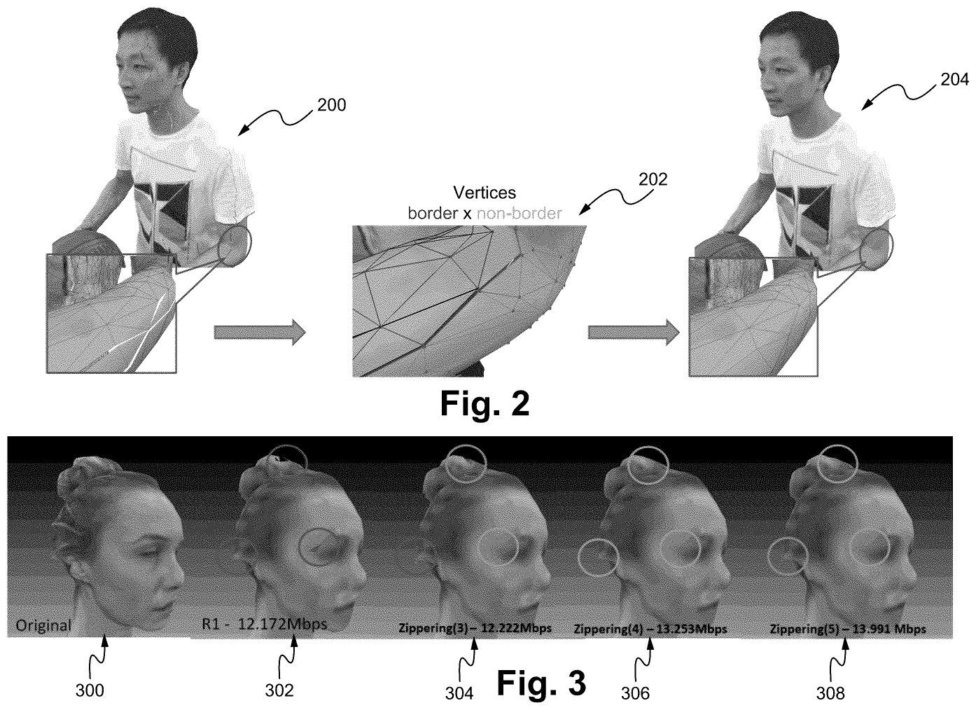

FIG. 2 illustrates images of aspects of zippering according to some embodiments. An image 200 is able to have gaps between border points. In image 202, zippering is applied to border vertices to narrow or eliminate the gaps. As described, zippering involves: classifying vertices as bordering vertices or non-bordering vertices, determining neighbors of the bordering vertices and merging the neighboring bordering vertices. Image 204, shows a decoded image without gaps by utilizing zippering.

FIG. 3 illustrates images showing advantages and disadvantages of each zippering implementation according to some embodiments. Image 300 is the original image. Image 302 shows without zippering-12.172 Mbps. Image 304 shows zippering-12.222 Mbps. Image 306 shows zippering-13.253 Mbps. Image 308 shows zippering-13.991 Mbps. By zippering, gaps are able to be filled such as in the face, hair and ear.

The updated zippering syntax is described herein:

| | Descriptor |
|---|---|
| geometry_smoothing( payloadSize ) { | |
| gs_persistence_flag | u(1) |
| gs_reset_flag | u(1) |
| gs_instances_updated | u(8) |
| for( i = 0; i < gs_instances_updated; i++ ) { | |
| gs_instance_index[ i ] | u(8) |
| k = gs_instance_index[ i ] | |
| gs_instance_cancel_flag[ k ] | u(1) |
| if( gs_instance_cancel_flag[ k] != 1 ) { | |
| gs_method_type[ k ] | ue(v) |
| if( gs_method_type[ k ] == 1 ) { | |
| gs_filter_eom_points_flag[ k ] | u(1) |
| gs_grid_size_minus2[ k ] | u(5) |
| gs_threshold[ k ] | u(8) |
| } | |
| if( gs_method_type[ k ] == 2 ) { | |
| gs_zippering_max_match_distance[ k ] | ue(v) |
| if( gs_zippering_max_match_distance_per_frame[ k ] != 0 ) { | |
| gs_zippering_send_border_point_match[ k ] | u(1) |
| if( gs_zippering_send_border_point_match[ k ] ) { | |
| gs_zippering_number_of_patches[ k ] | ue(v) |
| numPatches = gs_zippering_number_of_patches[ k ] | ue(v) |
| for( p = 0; p < numPatches; p++ ) | |
| gs_zippering_number_of_border_points[ k ][ p ] | ue(v) |
| for( p = 0; p < numPatches; p++ ) { | |
| numBorderPoints = gs_zippering_number_of_border_points[ k ][ p ] | |
| for( b = 0; b < numBorderPoints ; b++ ) { | |
| if( zipperingBorderPointMatchIndexFlag[ k ][ p ][ b ] == 0) { | |
| gs_zippering_border_point_match_patch_index[ k ][ p ][ b ] | u(v) |
| patchIndex = gs_zippering_border_point_match_patch_index[ k ][ p ] | |
| [ b ] | |
| if( patchIndex != numPatches ) { | |
| gs_zippering_border point_match_border_point_index[ k ][ p ][ b] | u(v) |
| borderIndex=gs_zippering_border_point_match_border_point_ | |
| index[ k ][ p ][ b ] | |
| if( patchIndex > p) | |
| zipperingBorderPointMatchIndexFlag[ k ][ patchIndex ] | |
| [ borderIndex ] = 1 | |
| } | |
| } | |
| } | |
| } | |
| } else { | |
| gs_zippering_send_distance_per_patch[ k ] | u(1) |
| gs_zippering_send_distance_per_border_point[ k ] | u(1) |
| if( gs_zippering_send_distance_per_patch[ k ] ) { | |
| gs_zippering_number_of_patches[ k ] | ue(v) |
| numPatches = gs_zippering_number_of_patches[ k ] | ue(v) |
| for( p = 0; p < numPatches; p++ ) { | |
| gs_zippering_max_match_distance_per_patch[ k ][ p ] | u(v) |
| if( gs_zippering_max_match_distance_per_patch[ k ][ p ] != 0 ) { | |
| if( gs_zippering_send_distance_per_border_point[ k ][ p ] == 1 ) { | |
| gs_zippering_number_of_border_points[ k ][ p ] | ue(v) |
| numBorderPoints = gs_zippering_number_of_border_points[ k ][ p ] | |
| for( b = 0; b < numBorderPoints ; b++ ) | |
| gs_zippering_border_point_distance[ k ][ p ][ b ] | i(v) |
| } | |
| } | |
| } | |
| } | |
| } | |
| } | |
| } | |
| } | |

gs_zippering_max_match_distance[k] specifies the value of the variable zipperingMaxMatchDistance[k] used for processing the current mesh frame for geometry smoothing instance with index k when the zippering filtering process is used. gs_zippering_send_border_point_match[k] equal to 1 specifies that zippering by transmitting matching indices is applied to border points for the geometry smoothing instance with index k. gs_zippering_send_border_point_match[k] equal to 0 specifies that zippering by transmitting matching indices is not applied to border points for the geometry smoothing instance with index k. The default value of gs_zippering_send_border_point_match[k] is equal to 0. gs_zippering_number_of_patches[k] indicates the number of patches that are to be filtered by the current SEI message. The value of gs_zippering_number_of_patches shall be in the range from 0 to MaxNumPatches[frameIdx], inclusive. The default value of gs_zippering_number_of_patches is equal to 0
gs_zippering_number_of_border points[k][p] indicates the number of border points numBorderPoints[p] of a patch with index p.
gs_zippering_border_point_match_patch_index[k][p][b] specifies the value of the variable zipperingBorderPointMatchPatchIndex[k][p][b] used for processing the current border point with index b, in the current patch with index p, in the current mesh frame for geometry smoothing instance with index k when the zippering filtering process is used. gs_zippering_border_point_match_border_point_index[k][p][b] specifies the value of the variable zipperingBorderPointMatchBorderPointIndex[k][p][b] used for processing the current border point with index b, in the current patch with index p, in the current mesh frame for geometry smoothing instance with index k when the zippering filtering process is used gs_zippering_send_distance_per_patch[k] equal to 1 specifies that zippering by transmitting matching distance per patch is applied to border points for the geometry smoothing instance with index k. gs_zippering_send_distance_per_patch[k] equal to 0 specifies that zippering by matching distance per patch is not applied to border points for the geometry smoothing instance with index k. The default value of gs_zippering_send_distance_per_patch[k] is equal to 0. gs_zippering_send_distance_per_border point[k] equal to 1 specifies that zippering by transmitting matching distance per border point is applied to border points for the geometry smoothing instance with index k. gs_zippering_send_distance_per_border_point [k] equal to 0 specifies that zippering by matching distance per border point is not applied to border points for the geometry smoothing instance with index k. The default value of gs_zippering_send_distance_per_border_point [k] is equal to 0. gs_zippering_max_match_distance_per_patch[k] specifies the value of the variable zipperingMaxMatchDistancePerPatch[k][p] used for processing the current patch with index p in the current mesh frame for geometry smoothing instance with index k when the zippering filtering process is used.
gs_zippering_border_point_distance[k][p][b] specifies the value of the variable zipperingMaxMatchDistancePerBorderPoint[k][p][b] used for processing the current border point with index b, in the current patch with index p, in the current mesh frame for geometry smoothing instance with index k when the zippering filtering process is used.

As described, trade-off is able to be achieved by choosing different zippering methods. Sending a single distance for the entire sequence uses just one single SEI message, while sending the distance per frame, patch or border distance includes sending SEI messages every frame. However, the subjective impact may be significant, since holes may or may not be visible, depending on the zippering method chosen.

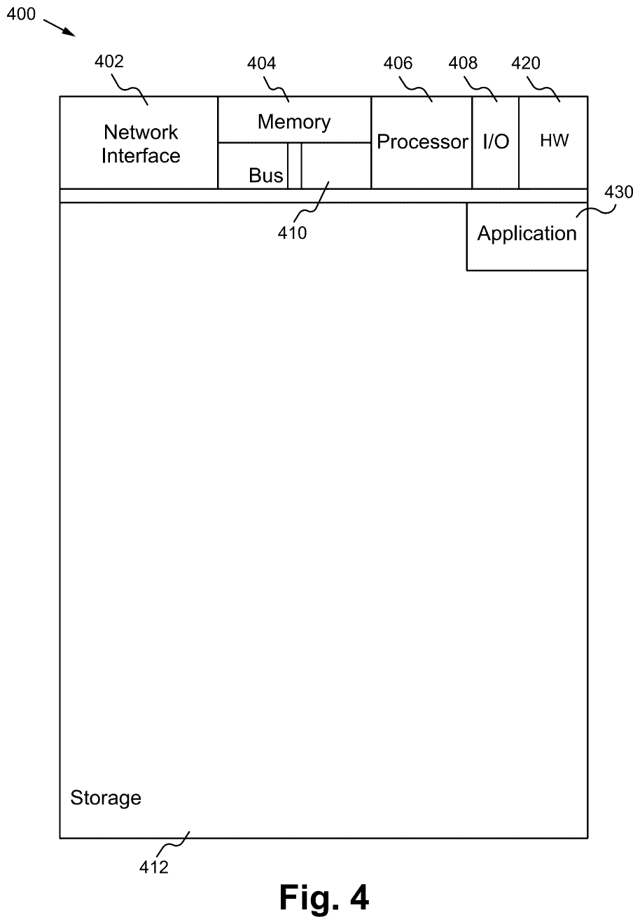

FIG. 4 illustrates a block diagram of an exemplary computing device configured to implement the mesh zippering method according to some embodiments. The computing device 400 is able to be used to acquire, store, compute, process, communicate and/or display information such as images and videos including 3D content. The computing device 400 is able to implement any of the encoding/decoding aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. Mesh zippering application(s) 430 used to implement the mesh zippering implementation are likely to be stored in the storage device 412 and memory 404 and processed as applications are typically processed. More or fewer components shown in FIG. 4 are able to be included in the computing device 400. In some embodiments, mesh zippering hardware 420 is included. Although the computing device 400 in FIG. 4 includes applications 430 and hardware 420 for the mesh zippering implementation, the mesh zippering method is able to be implemented on a computing device in hardware, firmware, software or any combination thereof. For example, in some embodiments, the mesh zippering applications 430 are programmed in a memory and executed using a processor. In another example, in some embodiments, the mesh zippering hardware 420 is programmed hardware logic including gates specifically designed to implement the mesh zippering method.

In some embodiments, the mesh zippering application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

Since sub-meshes are processed independently, the reconstructed mesh may have gaps between sub-meshes due to vertex position quantization and coding artifacts, generating a mismatch between the sub-mesh borders leading to visual artifacts including gaps between sub-meshes. However, if it is assumed that the reconstructed mesh should be a manifold, the gaps should not exist. This is a common problem in mesh generation using range images, and a solution is the zippering algorithm, merging triangle vertices that belong to the border of a sub-mesh.

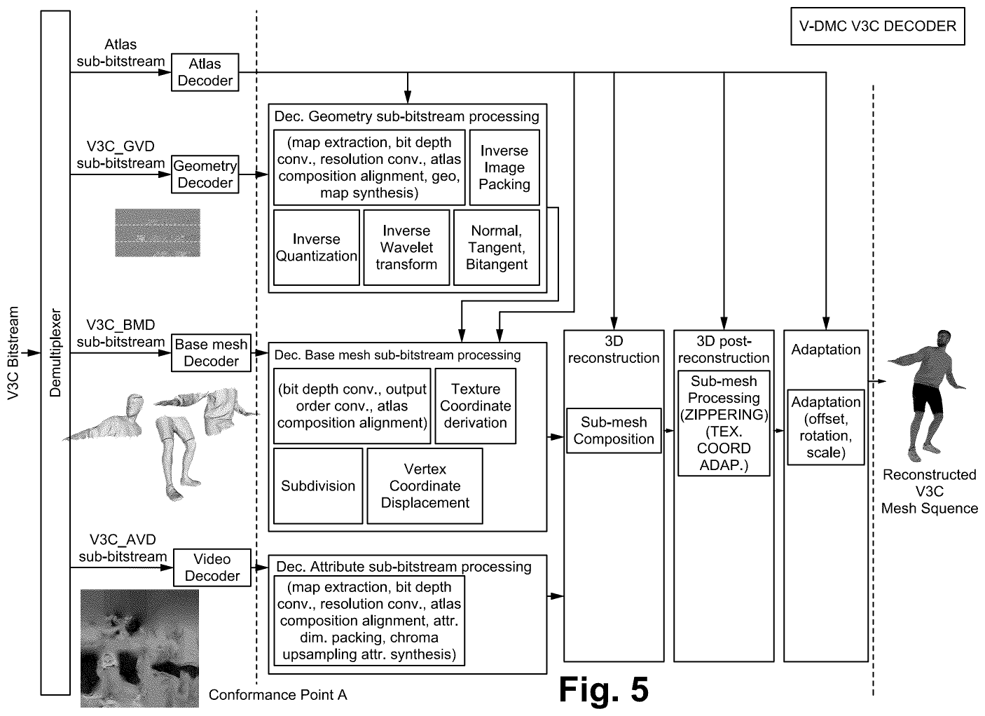

As described, zippering changes vertex position of border vertices to match sides of triangles being encoded separately. The zippering is able to be applied to the various patches generated. The same concept can be applied to sub-meshes instead. Furthermore, this is a 3D reconstruction issue, as shown in FIG. 5, since many other zippering methods could be implemented, and similar to the geometry smoothing concept for V-PCC, a new SEI message for zippering operations is able to be applied.

### Zippering

The zippering method searches (e.g., within a 3D sphere) for matches between boundary points/vertices from different sub-meshes according to a given geometry distortion distance that can be defined per sequence, per frame, per sub-mesh or even per boundary vertex. Furthermore, to reduce search complexity, the transmission of explicit matches between boundary vertex indices has been added. The encoder can choose between 6 different zippering methods:

(zipperingMethod=0) a user-defined search distance, (zipperingMatchMaxDistance=5(default)) for the entire sequence,

(zipperingMethod=1) a single search distance obtained from the maximum geometry distortion of all border vertices in all sub-meshes and in all frames,

(zipperingMethod=2) a search distance per frame obtained from the maximum geometry distortion of all border vertices in all sub-meshes,

(zipperingMethod=3) a set of search distances per sub-mesh per frame obtained from the maximum geometry distortion of all border vertices,

(zipperingMethod=4) the geometry distortion of every boundary vertex,

(zipperingMethod=5) the matching index between two boundary vertices.

The user-defined search is also referred to as a per sequence search where the search value is fixed (e.g., search with a 3D radius of 2).

A maximum geometry distortion search first performs an analysis of a sequence to determine the geometry distortion for each frame (e.g., 1, 4, 3, and so on) and then the maximum value (e.g., 4) is used for the entire sequence.

A maximum geometry distortion per frame implementation determines distances for each border vertex in a single frame, and the maximum value is used.

A maximum geometry distortion per sub-mesh is similar to the per frame implementation but instead is based on each sub-mesh.

In a per boundary point implementation, for each boundary point, the distance for each border vertex to another vertex is sent.

In a boundary pair implementation, instead of sending a distance, matched boundary pairs are sent (e.g., vertex 1 matches with vertex 3 from sub-mesh 4).

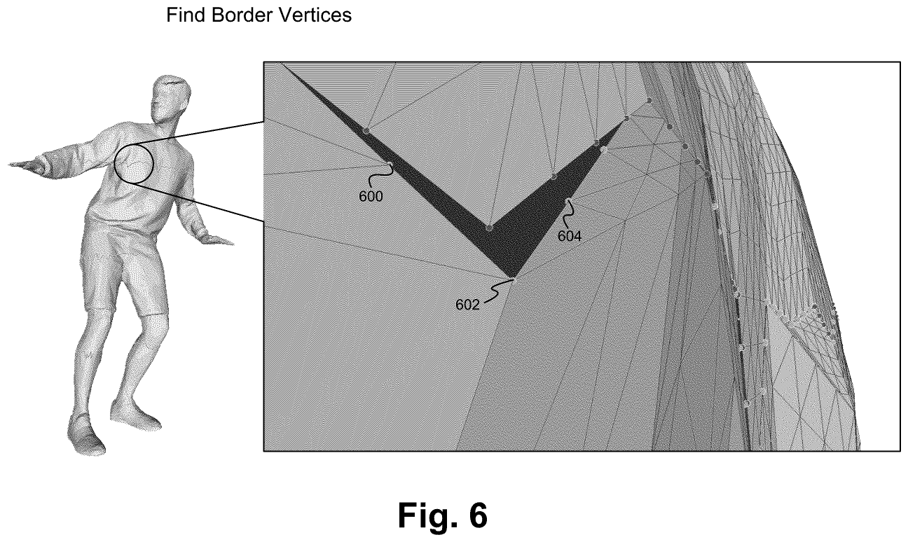

FIG. 6 illustrates an image of finding border vertices according to some embodiments. Border vertices (e.g., 600, 602 and 604) are found by determining each vertex on an edge that does not have two triangles connected to the edge.

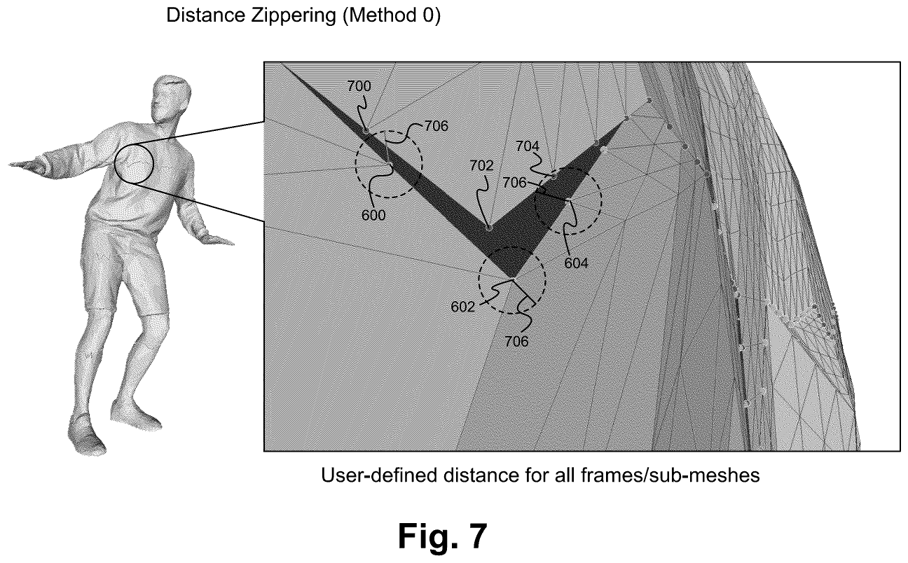

FIG. 7 illustrates an image of Method 0 of distance zippering according to some embodiments. With Method 0 of distance zippering, a user-defined distance for all frames/sub-frames is used. For example, a radius of 5 is used. As shown, the radius 706 of 5 may be large enough for some points to connect with a border vertex. For example, point 704 is within a radius 706 of 5 from its nearest border vertex 604. However, some points may not be within the radius of 5 to connect with a border vertex. For example, points 700 and 702 are not within the radius 706 of 5 from their respective nearest border vertices 600 and 602. In some embodiments, the user-defined distance is determined by Artificial Intelligence (AI)/Machine Learning (ML).

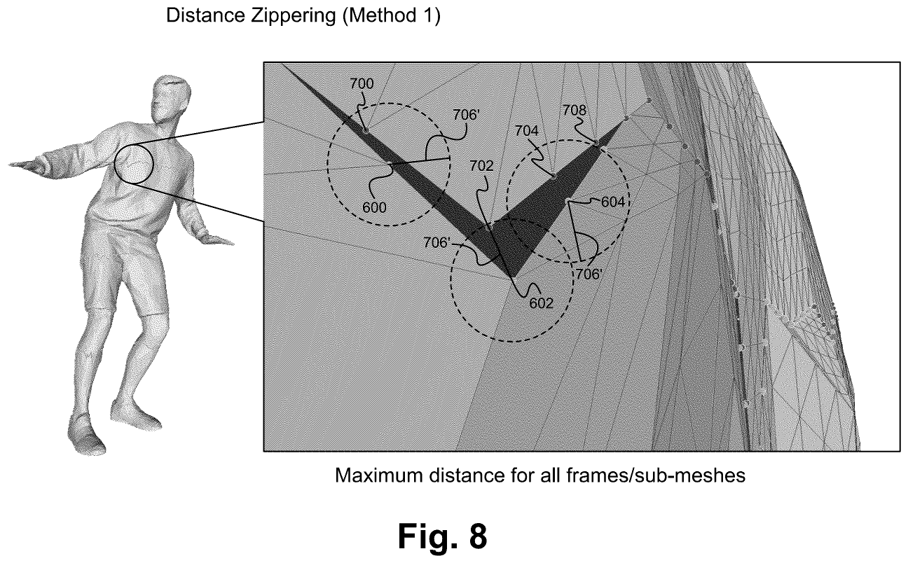

FIG. 8 illustrates an image of Method 1 of distance zippering according to some embodiments. With Method 1 of distance zippering, a maximum distance for all frames/sub-meshes is determined. For example, the distance from border vertex 600 to border vertex 700 is 7; the distance from border vertex 602 to border vertex 702 is 10; and the distance from border vertex 604 to border vertex 704 is 5. Therefore, since 10 is the largest distance (e.g., maximum distance), a radius 706′ of 10 is used. When using a radius 706′ of 10, all three border vertices 600, 602 and 604 find matching vertices 700, 702 and 704, respectively. In some instances, there may be more than one matching candidate vertex (e.g., vertices 704 and 708), so one of the candidate vertices is selected (e.g., the closest vertex is selected, or the selection is based on other criteria).

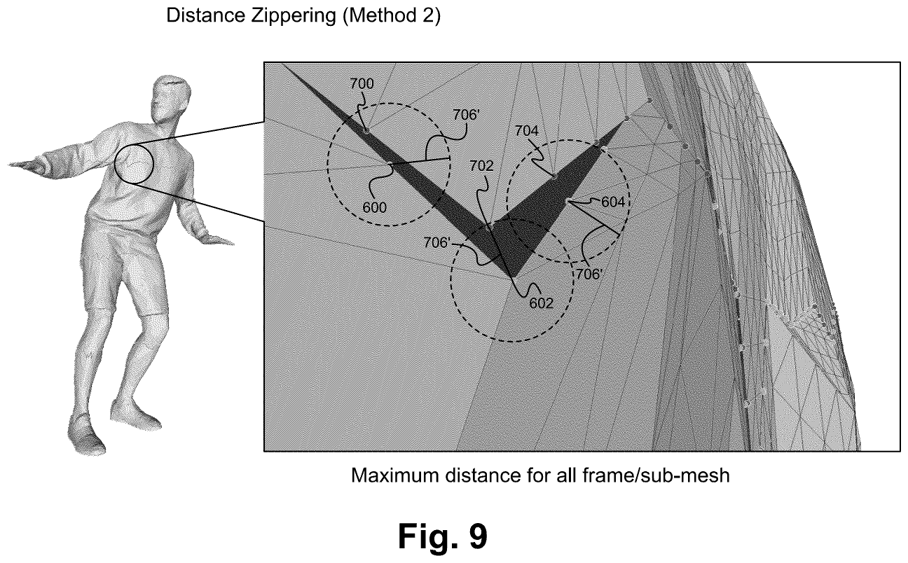

FIG. 9 illustrates an image of Method 2 of distance zippering according to some embodiments. With Method 2 of distance zippering, a maximum distance for each frame/sub-mesh is determined. Method 2 is similar to Method 1, except a new maximum distance is determined for each frame/sub-mesh instead of using the same maximum distance for all of the frames/sub-meshes.

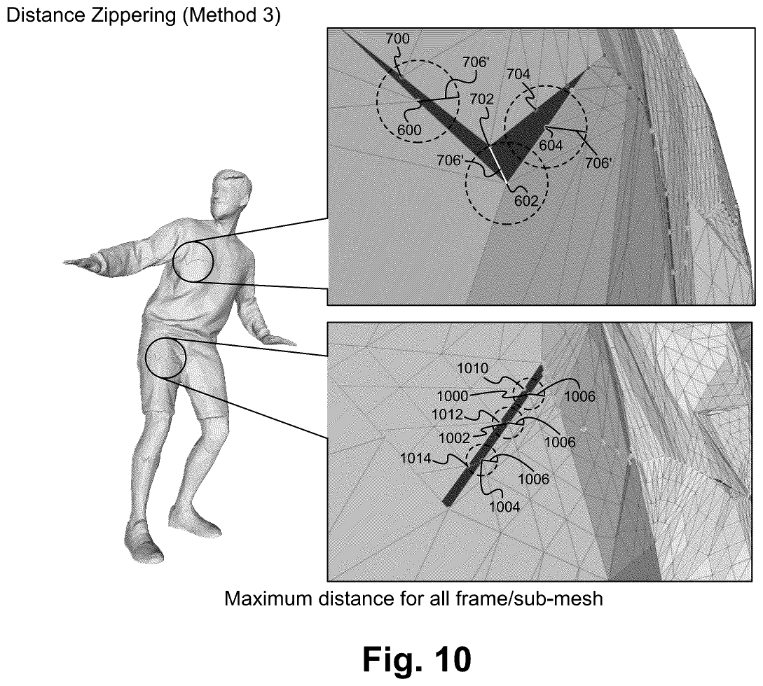

FIG. 10 illustrates an image of Method 3 of distance zippering according to some embodiments. With Method 3 of distance zippering, a maximum distance for each sub-mesh is determined. Method 3 is similar to Method 2, except a new maximum distance is determined for each sub-mesh.

As shown previously, for a first sub-mesh, the maximum distance from the vertices 600, 602 and 604 to vertices 700, 702 and 704, respectively, is 10, for example. For a second sub-mesh, the maximum distance from the vertices 1000, 1002 and 1004 to vertices 1010, 1012 and 1014, respectively is 4, for example, which results in a radius 1006 of 4. Thus, a smaller radius results in a smaller search area for the second sub-mesh.

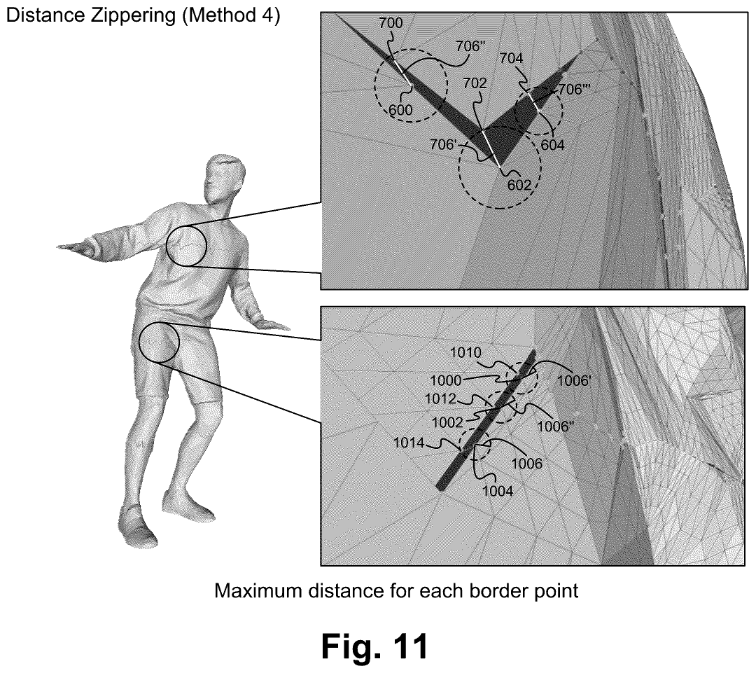

FIG. 11 illustrates an image of Method 4 of distance zippering according to some embodiments. With Method 4 of distance zippering, a maximum distance for each border point is determined. In other words, the distance from each border vertex to the nearest border vertex is determined. For example, the distance from border vertex 600 to border vertex 700 is 7; thus, the maximum distance or radius 706″ is 7. The distance from border vertex 602 to border vertex 702 is 10; thus, the radius 706′ is 10. The distance from border vertex 604 to border vertex 704 is 5; thus, the radius 706″ is 5. Similarly, the distance from border vertex 1000 to border vertex 1010 is 3; thus, the maximum distance or radius 1006′ is 3. The distance from border vertex 1002 to border vertex 1012 is 2; thus, the radius 1006″ is 2. The distance from border vertex 1004 to border vertex 1014 is 4; thus, the radius 1006 is 4. All of the separate distances are transmitted to another device which increases the bitrate but provides more accurate results.

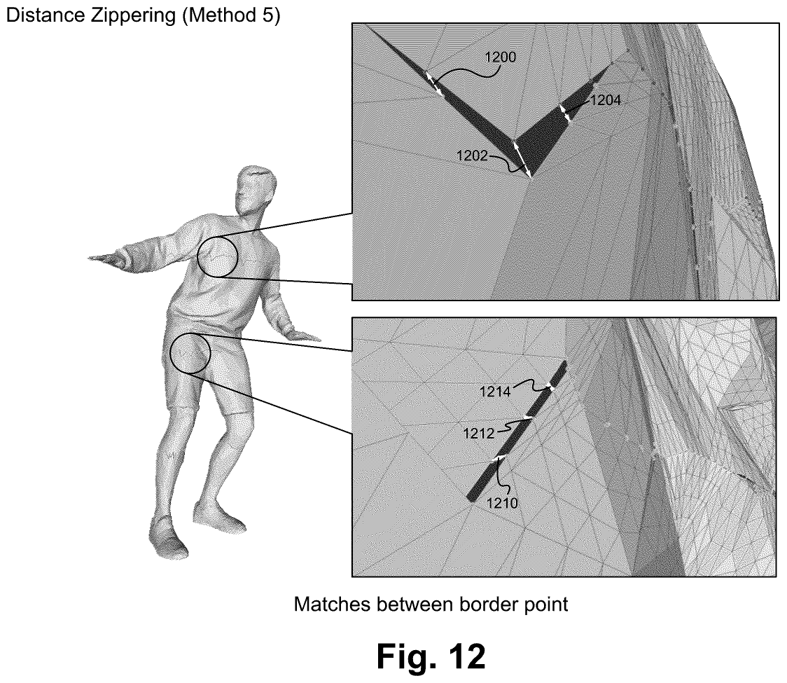

FIG. 12 illustrates an image of Method 5 of distance zippering according to some embodiments. With Method 5 of distance zippering, matches between border points are determined and sent. The matching pair of points is indicated by a sub-mesh index and a border point index. For example, the pairs 1200, 1202, 1204, 1210, 1212 and 1214 are shown. The pairs are able to be determined as described herein by determining a nearest neighboring vertex to a border vertex based on distance.

After the distance information, vertex information and/or pair information are determined, the information is able to be transmitted to another device (e.g., a decoder).

### High-Level Syntax

In the V3C standard, a new SEI message called zippering is able to be generated, with the payload equals to 68, which is still available.

```
sei_payload( payloadType, payloadSize ) {
      if(( nal_unit_type == NAL_PREFIX_NSEI ) ||
      ( nal_unit_type == NAL PREFIX_ESEI )) {
            if( payloadType == 0 )
                  buffering_period( payloadSize )
            else if( payloadType == 1 )
                  atlas_frame_timing( payloadSize )
            else if( payloadType == 2 )
                  filler_payload( payloadSize )
            else if( payloadType == 3 )
                  user_data_registered_itu_t_t35( payloadSize )
            else if( payloadType == 4 )
                  user_data_unregistered( payloadSize )
            else if( payloadType == 5 )
                  recovery_point( payloadSize )
            else if( payloadType == 6 )
                  no_reconstruction( payloadSize )
            else if( payloadType == 7)
                  time_code( payloadSize )
            else if( payloadType == 8 )
                  sei_manifest( payloadSize )
            else if( payloadType == 9 )
                  sei_prefix_indication( payloadSize )
            else if( payloadType == 10 )
                  active_sub_bitstreams( payloadSize )
            else if( payloadType == 11 )
                  component_codec_mapping( payloadSize )
            else if( payloadType == 12)
                  scene_object_information( payloadSize )
            else if( payloadType == 13 )
                  object_label_information( payloadSize )
            else if( payloadType == 14)
                  patch_information( payloadSize )
            else if( payloadType == 15 )
                  volumetric_rectangle_information( payloadSize )
            else if( payloadType == 16 )
                  atlas_object_association( payloadSize )
            else if( payloadType == 17)
                  viewport_camera_parameters( payloadSize )
            else if( payloadType == 18 )
                  viewport position( payloadSize )
            else if( payloadType == 20 )
                  packed_independent_regions( payloadSize )
            else if( payloadType == 64 )
                  attribute_transformation_params( payloadSize )
            else if( payloadType == 65 )
                  occupancy_synthesis( payloadSize )
            else if( payloadType == 66 )
                  geometry_smoothing( payloadSize )
            else if( payloadType == 67)
                  attribute_smoothing( payloadSize )
            else if( payloadType == 68 )
                  zippering( payloadSize )
            else if( payloadType == 128 )
                  viewing_space( payloadSize )
            else if( payloadType == 129)
                  viewing_space_handling( payloadSize )
            else if( payloadType == 130 )
                  geometry_upscaling_parameters( payloadSize )
            else
                  reserved_sei_message( payloadSize )
      }
      else { /*( nal_unit_type == NAL_SUFFIX_NSEI ) || ( nal_unit_type ==
NAL_SUFFIX_ESEI )*/
            if( payloadType == 2 )
                  filler_payload( payloadSize )
            else if( payloadType == 3 )
                  user_data_registered_itu_t_t35( payloadSize )
            else if( payloadType == 4 )
                  user_data_unregistered( payloadSize )
            else if( payloadType == 19)
                  decoded atlas information_hash( payloadSize )
            else
                  reserved_sei_message( payloadSize )
      }
      if( more_data_in_payload( ) ) {
            if( payload_extension_present( ) )
                  sp_reserved_payload_extension_data   u(v)
            byte_alignment( )
      }
}
```

The SEI message would have the following syntax:

| | Descriptor |
|---|---|
| zippering( payloadSize ) { | |
| zp_persistence_flag | u(1) |
| zp_reset_flag | u(1) |
| zp_instances_updated | u(8) |
| for( i = 0; i < zp_instances_updated; i++ ) { | |
| zp_instance_index[ i ] | |
| k = zp_instance_index[ i ] | u(8) |
| zp_instance_cancel_flag[ k ] | u(1) |
| if( zp_instance_cancel_flag[ k ] != 1 ) { | |
| zp_method_type[ k ] | ue(v) |
| if( zp_method_type[ k ] == 1) { | |
| zp_zippering_max_match_distance[ k ] | ue(v) |
| if( zp_zippering_max_match_distance_per_frame[ k ] != 0 ) { | |
| zp_zippering_send_distance_per_submesh[ k ] | u(1) |
| if( zp_zippering_send_distance_per_submesh[ k ] ) { | |
| zp_zippering_number_of_submeshes[ k ] | ue(v) |
| numSubmeshes = | |
| zp_zippering_number_of_submeshes[ k ] | |
| for( p = 0; p < numSubmeshes ; p++ ) { | |
| zp_zippering_max_match_distance_per_submesh[ k ][ p ] | u(v) |
| if( | |
| zp_zippering_max_match_distance_per_submesh[ k ][ p ] != 0 ) { | |
| zp_zippering_send_distance_per_border_point[ k ][ p ] | u(1) |
| if( | |
| zp_zippering_send_distance_per_border_point[ k ][ p ] == 1) { | |
| zp_zippering_number_of_border_points[ k ][ p ] | ue(v) |
| numBorderPoints = | |
| zp_zippering_number_of_border_points[ k ][ p ] | |
| for( b = 0; b < | |
| numBorderPoints ; b++ ) | |
| zp_zippering_border_point_distance[ k ][ p ][ b ] | u(v) |
| } | |
| } | |
| } | |
| } | |
| } | |
| } | |
| if( zp_method_type[ k ] == 2 ) { | |
| zp_zippering_number_of_submeshes[ k ] | ue(v) |
| numSubmeshes = zp_zippering_number_of_submeshes[ k ] | ue(v) |
| for( p = 0; p < numSubmeshes; p++ ) | |
| zp_zippering_number_of_border_points[ k ][ p ] | ue(v) |
| for( p = 0; p < numSubmeshes; p++ ) { | |
| numBorderPoints = | |
| zp_zippering_number_of_border_points[ k ][ p ] | |
| for( b = 0; b < numBorderPoints ; b++ ) { | |
| if( zipperingBorderPointMatchIndexFlag[ k ][ p ] | |
| [ b ] == 0) { | |
| zp_zippering_border_point_match_submesh_index[ k ][ p ][ b ] | u(v) |
| submeshIndex = | |
| zp_zippering_border_point_match_submesh_index[ k ][ p ][ b ] | |
| if( submeshIndex != numSubmeshes ) { | |
| zp_zippering_border_point_match_border_point_index[ k ][ p ][ b ] | u(v) |
| borderIndex=zp_zippering_border_point_match_border_point_index[ k ][ p ][ b ] | |
| if( submeshIndex > p) | |
| zipperingBorderPointMatchIndexFlag[ k ][ submeshIndex ][ borderIndex ] = 1 | |
| } | |
| } | |
| } | |
| } | |
| } | |
| } | |
| } | |

### Semantics

The SEI message specifies the recommended zippering methods and their associated parameters that could be used to process the vertices of the current mesh frame after it is reconstructed, so as to obtain improved reconstructed geometry quality.

Up to 256 (or another number) different zippering instances could be specified for use with each mesh frame. These instances are indicated using an array ZipperingMethod. The zippering instance that a decoder may select to operate in, is outside the scope of this document. At the start of each sequence, let ZipperingMethod[i] be set equal to 0, where i corresponds to the zippering instance index and is in the range of 0 to 255, inclusive. When ZipperingMethod[i] is equal to 0 it means that no zippering filter is indicated for the zippering instance with index i. zp_persistence_flag specifies the persistence of the zippering SEI message for the current layer. zp_persistence_flag equal to 0 specifies that the zippering SEI message applies to the current decoded atlas frame only.

Let aFrmA be the current atlas frame. zp_persistence_flag equal to 1 specifies that the zippering SEI message persists for the current layer in output order until any of the following conditions are true: a new CAS begins, the bitstream ends, and an atlas frame aFrmB in the current layer in a coded atlas access unit containing a zippering SEI message with the same value of zp_persistence_flag and applicable to the current layer is output for which AtlasFrmOrderCnt(aFrmB) is greater than AtlasFrmOrderCnt(aFrmA), where AtlasFrmOrderCnt(aFrmB) and AtlasFrmOrderCnt(aFrmA) are the AtlasFrmOrderCntVal values of aFrmB and aFrmA, respectively, immediately after the invocation of the decoding process for atlas frame order count for aFrmB.

zp_reset_flag equal to 1 resets all entries in the array ZipperingMethod to 0 and all parameters associated with this SEI message are set to their default values.

zp_instances_updated specifies the number of zippering instances that will be updated in the current zippering SEI message.

zp_instance_index[i] indicates the i-th zippering instance index in the array ZipperingMethod that is to be updated by the current SEI message.

zp_instance_cancel_flag[k] equal to 1 indicates that the value of ZipperingMethod[k] and that all parameters associated with the zippering instance with index k should be set to 0 and to their default values, respectively.

zp_method_type[k] indicates the zippering method, ZipperingMethod[k], that can be used for processing the current mesh frame as specified in Table 1 for zippering instance with index k.

TABLE 1
Definition of zp_method_type[k]

| Value | Interpretation |
|---|---|
| 0 | No Zippering |
| 1 | Distance Zippering |
| 2 | Border Point Match Zippering |
| 3 | Reserved |

Values of zp_method_type[k] greater than 2 are reserved for future use by ISO/IEC. It is a requirement of bitstream conformance that bitstreams conforming to this version of this document shall not contain such values of zp_method_type[k]. Decoders shall ignore zippering SEI messages that contain reserved values of zp_method_type[k]. The default value of zp_method_type[k] is equal to 0.

zp_zippering_max_match_distance[k] specifies the value of the variable zipperingMaxMatchDistance[k] used for processing the current mesh frame for zippering instance with index k when the zippering filtering process is used.

zp_zippering_send_distance_per_submesh[k] equal to 1 specifies that zippering by transmitting matching distance per sub-mesh is applied to border points for the zippering instance with index k. zp_zippering_send_distance per_submesh[k] equal to 0 specifies that zippering by matching distance per sub-mesh is not applied to border points for the zippering instance with index k. The default value of zp_zippering_send_distance_per_submesh[k] is equal to 0.

zp_zippering_number_of_submeshes[k] indicates the number of sub-meshes that are to be zippered by the current SEI message. The value of zp_zippering_number_of_submeshes shall be in the range from 0 to MaxNumSubmeshes [frameldx], inclusive. The default value of zp_zippering_number_of_submeshes is equal to 0. zp_zippering_max_match_distance_per_submesh[k][p] specifies the value of the variable zipperingMaxMatchDistancePerPatch[k][p] used for processing the current sub-mesh with index p in the current mesh frame for zippering instance with index k when the zippering process is used. The length of the zp_zippering_max_match_distance_per_submesh[k][p] syntax element is Ceil(Log2(zp_zippering_max_match_distance[k])) bits.

zp_zippering_send_distance per border point[k] equal to 1 specifies that zippering by transmitting matching distance per border point is applied to border points for the zippering instance with index k. zp_zippering_send_distance_per_border point [k] equal to 0 specifies that zippering by matching distance per border point is not applied to border points for the zipperinginstance with index k. The default value of zp_zippering_send_distance_per_border point[k] is equal to 0.

zp_zippering_number_of_border_points[k][p] indicates the number of border points numBorderPoints[p] of a sub-mesh with index p, in the current mesh frame for zippering instance with index k when the zippering process is used.

zp_zippering_border point_distance[k][p][b] specifies the value of the variable zipperingMaxMatchDistancePerBorderPoint[k][p][b] used for processing the current border point with index b, in the current sub-mesh with index p, in the current mesh frame for zippering instance with index k when the zippering process is used. The length of the zp_zippering_border_point_distance[k][p][b] syntax element is Ceil(Log2(zp_zippering_max_match_distance_per_submesh[k][p])) bits.

zp_zippering_border_point_match_submesh_index[k][p][b] specifies the value of the variable zipperingBorderPointMatchSubmeshIndex[k][p][b] used for processing the current border point with index b, in the current sub-mesh with index p, in the current mesh frame for zippering instance with index k when the zippering process is used. The length of the zp_zippering_border_point_match_submesh_index[k][p][b] syntax element is Ceil(Log2(zp_zippering_number_of_submeshes[k])) bits.

zp_zippering_border_point_match_border_point_index[k][p][b] specifies the value of the variable zipperingBorderPointMatchBorderPointIndex[k][p][b] used for processing the current border point with index b, in the current patch with index p, in the current mesh frame for zippering instance with index k when the zippering filtering process is used. The length of the zp_zippering_border point_match_border_point_index[k][p][b] syntax element is Ceil(Log2(zp_zippering_number_of_border points[k][zp_zippering_border point_match_submesh_index[k][p][b] ])) bits.

### Reconstruction

The border vertices of each sub-mesh are detected. If the SEI indicates distance-matching, the matches between two border vertex are searched for by checking the distance between them, given a certain threshold (which can be defined by sequence/frame/sub-mesh/border), and fill in a structure with the boundary vertex pairs. Otherwise, if the SEI message indicates index-matching, the boundary vertex pair structure is obtained directly from the SEI message. Then, the matched vertices will be fused together.

### Vertex Border Detection

From the code:

```
void zippering_find_borders(std::vector<TriangleMesh<MeshType>>& submeshes,
              std::vector<std::vector<int8_t>>& isBoundaryVertex,
              std::vector<size t>& numBoundaries,
              TriangleMesh<MeshType>& boundaryVertices)
```

### Find Vertex Match by Distance

From the code:

```
void zippering_find_matches(std::vector<TriangleMesh<MeshType>& submeshes,
      TriangleMesh<MeshType>& boundaryVertices,
      std::vector<size t>& numBoundaries,
      std::vector<std::vector<int64_t>>& zipperingDistanceBorderPoint,
      std::vector<std::vector<Vec2<size_t>>>& zipperingMatchedBorderPoint)
```

### Matched Vertex Zippering

From the code:

```
void zippering_fuse_border(std::vector<TriangleMesh<MeshType>& submeshes,
      std::vector<std::vector<int8 t>>& isBoundaryVertex,
      std::vector<std::vector<Vec2<size_t>>>& zipperingMatchedBorderPoint)
```

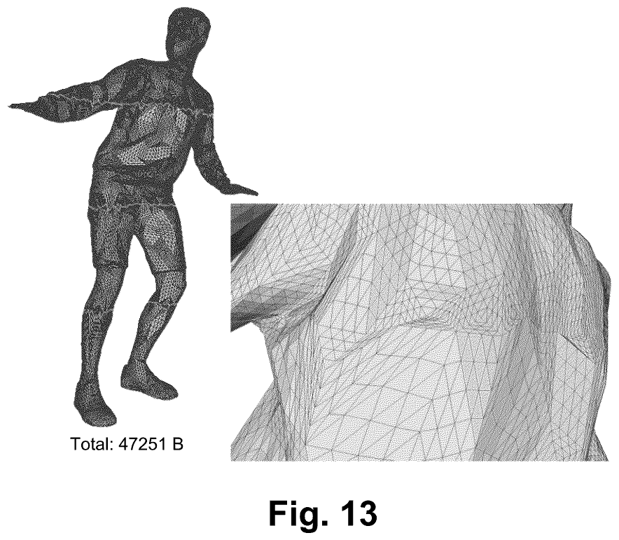

In FIG. 13, the results for the zippering algorithm are shown. The crack is corrected by the approach described herein. A fixed threshold for the frame was selected, the added bitrate was only a couple of bytes for the SEI message transmission, and if the same threshold can be used for the other frames, the impact of the SEI transmission is even smaller.

To utilize the mesh zippering method, a device acquires or receives 3D content (e.g., point cloud content). The mesh zippering method is able to be implemented with user assistance or automatically without user involvement.

In operation, the mesh zippering method enables more efficient and more accurate 3D content decoding compared to previous implementations.

### Some Embodiments of Sub-Mesh Zippering

1. A method programmed in a non-transitory memory of a device comprising:
   determining one or more border points in one or more sub-meshes;
   selecting a zippering implementation from a plurality of mesh zippering implementations; and
   merging each of the one or more border points with a corresponding point based on the selected mesh zippering implementation.
2. The method of clause 1 wherein the plurality of mesh zippering implementations comprise:
   a defined search distance implementation;
   a maximum distance in all sub-meshes and all frames implementation;
   a maximum distance per frame implementation;
   a maximum distance per sub-mesh implementation;
   a maximum distance of each boundary vertex; and
   a matching index between two boundary vertices.
3. The method of clause 2 wherein the defined search distance implementation uses a user-defined search distance.
4. The method of clause 2 wherein the defined search distance implementation uses a computer-generated search distance using artificial intelligence and machine learning.
5. The method of clause 2 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.
6. The method of clause 5 wherein the distance is a radius of a spherical search area.
7. The method of clause 1 wherein determining the one or more border points in the one or more sub-meshes includes determining each point on an edge that does not have two triangles connected to the edge.
8. An apparatus comprising:
   a non-transitory memory for storing an application, the application for:
      determining one or more border points in one or more sub-meshes;
      selecting a zippering implementation from a plurality of mesh zippering implementations; and
      merging each of the one or more border points with a corresponding point based on the selected mesh zippering implementation; and
   a processor coupled to the memory, the processor configured for processing the application.
9. The apparatus of clause 8 wherein the plurality of mesh zippering implementations comprise:
   a defined search distance implementation;
   a maximum distance in all sub-meshes and all frames implementation;
   a maximum distance per frame implementation;
   a maximum distance per sub-mesh implementation;
   a maximum distance of each boundary vertex; and
   a matching index between two boundary vertices.
10. The apparatus of clause 9 wherein the defined search distance implementation uses a user-defined search distance.
11. The apparatus of clause 9 wherein the defined search distance implementation uses a computer-generated search distance using artificial intelligence and machine learning.
12. The apparatus of clause 9 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.
13. The apparatus of clause 12 wherein the distance is a radius of a spherical search area.
14. The apparatus of clause 8 wherein determining the one or more border points in the one or more sub-meshes includes determining each point on an edge that does not have two triangles connected to the edge.
15. A system comprising:
   an encoder configured for encoding content; and
   a decoder configured for:
      determining one or more border points in one or more sub-meshes;
      selecting a zippering implementation from a plurality of mesh zippering implementations; and
      merging each of the one or more border points with a corresponding point based on the selected mesh zippering implementation.
   16. The system of clause 15 wherein the plurality of mesh zippering implementations comprise:
      a defined search distance implementation;
      a maximum distance in all sub-meshes and all frames implementation;
      a maximum distance per frame implementation;
      a maximum distance per sub-mesh implementation;
      a maximum distance of each boundary vertex; and
      a matching index between two boundary vertices.
   17. The system of clause 16 wherein the defined search distance implementation uses a user-defined search distance.
   18. The system of clause 16 wherein the defined search distance implementation uses a computer-generated search distance using artificial intelligence and machine learning.
   19. The system of clause 16 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.
   20. The system of clause 19 wherein the distance is a radius of a spherical search area.
   21. The system of clause 15 wherein determining the one or more border points in the one or more sub-meshes includes determining each point on an edge that does not have two triangles connected to the edge.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
determining one or more border points in one or more sub-meshes;
selecting a zippering implementation from a plurality of mesh zippering implementations; and
merging each of the one or more border points with a corresponding point based on the selected mesh zippering implementation.

2. The method of claim 1 wherein the plurality of mesh zippering implementations comprise:
a defined search distance implementation;
a maximum distance in all sub-meshes and all frames implementation;
a maximum distance per frame implementation;
a maximum distance per sub-mesh implementation;
a maximum distance of each boundary vertex; and
a matching index between two boundary vertices.

3. The method of claim 2 wherein the defined search distance implementation uses a user-defined search distance.

4. The method of claim 2 wherein the defined search distance implementation uses a computer-generated search distance using artificial intelligence and machine learning.

5. The method of claim 2 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.

6. The method of claim 5 wherein the distance is a radius of a spherical search area.

7. The method of claim 1 wherein determining the one or more border points in the one or more sub-meshes includes determining each point on an edge that does not have two triangles connected to the edge.

8. An apparatus comprising:
a non-transitory memory for storing an application, the application for:
determining one or more border points in one or more sub-meshes;
selecting a zippering implementation from a plurality of mesh zippering implementations; and
merging each of the one or more border points with a corresponding point based on the selected mesh zippering implementation; and
a processor coupled to the memory, the processor configured for processing the application.

9. The apparatus of claim 8 wherein the plurality of mesh zippering implementations comprise:
a defined search distance implementation;
a maximum distance in all sub-meshes and all frames implementation;
a maximum distance per frame implementation;
a maximum distance per sub-mesh implementation;
a maximum distance of each boundary vertex; and
a matching index between two boundary vertices.

10. The apparatus of claim 9 wherein the defined search distance implementation uses a user-defined search distance.

11. The apparatus of claim 9 wherein the defined search distance implementation uses a computer-generated search distance using artificial intelligence and machine learning.

12. The apparatus of claim 9 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.

13. The apparatus of claim 12 wherein the distance is a radius of a spherical search area.

14. The apparatus of claim 8 wherein determining the one or more border points in the one or more sub-meshes includes determining each point on an edge that does not have two triangles connected to the edge.

15. A system comprising:
an encoder configured for encoding content; and
a decoder configured for:
determining one or more border points in one or more sub-meshes;
selecting a zippering implementation from a plurality of mesh zippering implementations; and
merging each of the one or more border points with a corresponding point based on the selected mesh zippering implementation.

16. The system of claim 15 wherein the plurality of mesh zippering implementations comprise:
a defined search distance implementation;
a maximum distance in all sub-meshes and all frames implementation;
a maximum distance per frame implementation;
a maximum distance per sub-mesh implementation;
a maximum distance of each boundary vertex; and
a matching index between two boundary vertices.

17. The system of claim 16 wherein the defined search distance implementation uses a user-defined search distance.

18. The system of claim 16 wherein the defined search distance implementation uses a computer-generated search distance using artificial intelligence and machine learning.

19. The system of claim 16 wherein the defined search distance implementation, the maximum distance in all sub-meshes and all frames implementation, the maximum distance per frame implementation, the maximum distance per sub-mesh implementation, and the maximum distance of each boundary vertex each include limiting a scope of a search for the point based on distance.

20. The system of claim 19 wherein the distance is a radius of a spherical search area.

21. The system of claim 15 wherein determining the one or more border points in the one or more sub-meshes includes determining each point on an edge that does not have two triangles connected to the edge.
